(19) United States
(12) Patent Application Publication
(10) Pub. No.: US 2009/0000512 A1
(43) Pub. Date: Jan. 1, 2009

(54) Process for preparing a printing ink

(75) Inventors: Bjorn Erik Haabegaard Larsen, Stroby (DK); Robert Pedersen, Greve (DK); Palle Chris Nielsen, Klippinge (DK); Steffen Carrock Olsen, Farum (DK)

Correspondence Address: NORRIS, MCLAUGHLIN & MARCUS, PA, 875 THIRD AVENUE, 18TH FLOOR, NEW YORK, NY, 10022, US

(73) Assignee: SUN CHEMICAL CORPORATION, PARSIPPANY, NJ (US)

(21) Appl. No.: 11/442,805

(22) Filed: May 30, 2006

Related U.S. Application Data
(60) Provisional application No. 60/685,611, filed on May 27, 2005.

(51) Int. Cl. C09D 11/02

(52) U.S. Cl. 106/31.86; 106/31.6

(57) ABSTRACT

A printing ink and process for preparing by mixing an aqueous pigment slurry with at least one non-pigment ink component immiscible in water to form a flush cake which is processed to a finished printing ink.

### BACKGROUND OF THE INVENTION

1. Field of the Invention

The present invention relates generally to a novel process for preparing a printing ink, and to novel products produced during such process.

2. Description of Related Art

There are two primary commercial routes for producing a printing ink from an aqueous slurry of organic pigment. The “flushing process” includes pumping the pigment slurry to a filtering system, for example, via a filter press where the major part of the water is separated and soluble salts are removed. The resulting pigment press cake is then flushed in high shear grinding equipment like, for example, a sigma blade mixer. Oil, varnish, alkyd and/or other non-aqueous hydrophobic vehicles may be added and the pigment will eventually flush into the organic phase and leave the water phase clear of pigment. A substantial part of the water can then be poured off. In order to remove the remaining water, usually heat and vacuum must then be applied. The resulting product is called a “flush paste.” This can then be let down with further oil and varnish and other conventional printing ink vehicles to a finished printing ink in a high speed mixer.

The “dry grind process” also includes a filtration and washing step. The resulting press cake can either be dried directly as it is, followed by pulverization, or it can be re-suspended in demineralized water and spray-dried. The dry pigment powder can then be mixed with oil, varnish, alkyd and other non-aqueous hydrophobic vehicles to make a printing ink. Because sintering (hydrophilic aggregation) of the pigment during the drying process is almost unavoidable, the printing ink must then be transferred to grinding equipment like, for instance, a 3-roll-mill, before the printing ink is finished.

In the flushing process, in order to produce the press cake, highly expensive filtering equipment is needed, and the bigger the batch strike is, the more filtering capacity is necessary. The obtained press cake is sensitive to drying out, where sintering will occur, and because of the volume and relatively high water content in the press cake, this will have to be added to the mixer, where the flushing takes place, in several steps called “breaks.” The water squeezed out of the coherent flush has to be poured off in each break, causing a prolonged process time. Further, because of varying water content in the press cake, it is critical to measure the dry content of the press cake carefully and add the oil, varnish, alkyd and other non-aqueous hydrophobic vehicles accordingly.

It has previously been described to flush a slurry containing organic pigment in water to a non-aqueous phase in a tank with a high shear zone. For example, U.S. Pat. No. 5,108,509 describes how pigment/vehicle conglomerates are created when a hydrophobic vehicle is added to a pigment slurry. These conglomerates will eventually grow into clusters which can be filtered in, for example, a webbed nylon bag.

U.S. Pat. No. 4,664,710 describes how a pigment slurry is transferred to a high shear, high horsepower mixer to which the non-aqueous vehicles are added and water is removed in several breaks. European Patent No. 0 319 628 teaches how the strike is transferred to a horizontal cylindrical mixer equipped with high speed impellor blades and only one break.

Other patents, like U.S. Pat. No. 4,255,375, teach how pigment can be flushed with the aid of a compound, for example, an organic acid, which possesses the ability to change hydrophilicity due to pH changes. Also, U.S. Pat. No. 4,175,979 teaches how to make a pigment composition in bead form from an aqueous slurry of pigment in the presence of an aqueous protective colloid, e.g., hydroxyl ethyl cellulose or the like.

U.S. Pat. No. 4,910,236 describes how a pigment dispersion in organic non-aqueous vehicles is made by mixing an aqueous pigment slurry with an emulsion of organic non-aqueous vehicles in water. After concentration of the dispersed pigment, an ink is made on the water containing dispersed press cake.

Each of these known methods requires the use of high shear zones and/or the use of flushing-aid compounds that are not normal components of the finished printing ink. Accordingly, there remains a need in the art to find simple, efficient, economical means for processing aqueous pigment slurries to finished printing inks without such drawbacks.

### BRIEF SUMMARY OF THE INVENTION

These and other objects are met with the present invention, which relates to a process for preparing a printing ink, wherein the process comprises the following steps:
(a) providing an aqueous pigment slurry;
(b) adding at least one non-pigment printing ink component immiscible in water to said aqueous pigment slurry to produce a flush cake; and
(c) processing said flush cake to a finished printing ink.

The present invention further relates to a flush cake comprising a pigment and at least one non-pigment printing ink component immiscible in water.

The present invention also relates to a printing ink comprising a flush cake comprising a pigment and at least one non-pigment printing ink component immiscible in water, and a second non-pigment printing ink component immiscible in water.

### DETAILED DESCRIPTION OF THE INVENTION

It has been found that by adding oil and/or varnish and/or alkyd and/or other vehicles immiscible in water and mixtures thereof, which are normal components in a printing ink, to an aqueous pigment slurry, it is possible to obtain a preflushed product, preferably with the physical form of non-sticky beads, called “flush cake.”The flush cake is then processed to form a printing ink.

The aqueous pigment slurry is produced via known means and processes. The pigment may be an organic pigment, an inorganic pigment or dye.

The water immiscible printing ink component includes oils, varnish, alkyds and other vehicles. Suitable oils of the present invention include but are not limited to oils which have a melting point of about 200° C. to about 350° C., mineral oils known to be used in printing inks, and the reaction product of various glycols or polyglycols and linseed or other vegetable oils. Other immiscible in water oils for use in the printing ink of the invention, include, but are not limited to, modified or unmodified oils, linseed oil, olive oil, castor oil, soybean oil, other vegetable oils, fatty acid ester oil groups and Magiesol oils (such as Magie Sol 47LX manufactured by Magie Brothers), modified soy oils, phthallate esters, tallate esters, and mixtures thereof.

The varnish of the present invention may be any known printing ink varnish such as, but not limited to resins, rosins, rosin resins, asphaltic resins (Coblax), hydrocarbon resins, modified hydrocarbon resins, phenolic, rosins, rosin esters, modified rosins (phenolic, fumaric, maleic, etc.) esters, binder resins in an oil base for acting as a thixotropic/rheology adjusting agent and as a further solvent/vehicle for the oleophilic phase, and mixtures thereof.

Suitable alkyds of the present invention are any known alkyds used in printing inks. Some commercially available alkyds include Terlon F and Setalin V405.

Any other known printing ink vehicles which are immiscible in water may also be used in producing the flush cake and printing ink of the invention.

Moreover, conventional amounts of typical additives useful in printing inks may also be included in the printing ink of the present invention, including without limitation, defoamers, rheology agents, clays, waxes, silicas, dispersants, plasticizers, wetting agents, thickening agents, biocides, surfactants, corrosion inhibitors, polyamides and aluminum chelates, resins, and the like.

The flush cake is produced in a container, such as a tank, under normal agitation without the need for a high shear zone and without the need for any flushing-aid compounds that are not normal components in a printing ink. The flush cake can be filtered and washed either in conventional filtering units, but preferably in the transportation unit in which it is handled afterwards, for example, in an uncoated webbed nylon bag. The beads can then be made into a normal flush in a flusher, eliminating the water by means of heat and vacuum. Alternatively, and, very surprisingly, it has been found that a printing ink can be made directly from the flush cake. For example, all the conventional vehicles in a printing ink, for example, oil, varnish, alkyd, extender, and antioxidant, are mixed with the flush cake in a high speed mixer, and, simultaneously, the water can easily be removed by applying vacuum. The printing inks obtained by this method are the same quality as conventionally produced printing inks.

Preferably, flush cake can be obtained with a physical form and property that enables easy filtering and washing in a transportation unit, without the beads sticking together. This is done in a regular tank with a normal stirrer, i.e., an Ekato stirrer. After filtration, the flush cake can be processed further to a standardized flush and, because most of the water has been removed, there is no need for large mixers to contain the entire strike batch and no need for running several breaks. Furthermore, printing ink can easily be made with the product eliminating the conventional flush process, but without the risk of the pigment drying out, due to the fact that the pigment in the beads is already dispersed in flush vehicle.

The flush cake has advantages over both dry pigment and flushed color. Compared to dry pigment, it has the same advantages of a flushed color, i.e., non-dusting, more transparency, higher gloss, and higher color strength. Versus flush pigment, its biggest advantages lie in the manufacturing process. The material can go directly from flush cake to printing ink tank, eliminating the time and energy consuming flushing process, without losing any transparency, gloss, or color strength. Since the flush cake has a physical form that allows for fast filtering in transportation units like big bags, this eliminates the need for conventional filtration units. Also, the handling in connection with emptying finer presses and filling the press cake into transportation units are eliminated. A significant reduction in water consumption for washing of the flush cake, when compared to washing of a press cake in a conventional filter press, has also been achieved. Proportionally the effluent water from washing the pigment is reduced.

Another advantage of the flush cake, compared to normal press cake, is the fact that inventive flush cake seems not to be sensitive to drying out nor to freezing, which normally can cause serious problems in subsequent flushing of press cakes. In addition to this, the process time for subsequent flushing in, for example, a sigma blade mixer or similar type of equipment is reduced significantly, mainly due to the ability to perform only one break. In relation to this, it should also be noted that the energy consumption for flushing in the present invention is much reduced compared to conventional press cake flushing. The amount of material wasted due to handling of the pigment and flush in the conventional process is also reduced by the process of this invention. In addition to this, the flush cake also brings the benefit that dry content measurement of the press cake is not necessary, thereby reducing the labor request for taking press cake samples and measuring dry contents.

Furthermore, if printing ink is made on flush cake directly, the entire flushing step can be eliminated. Finally, since the pigment content in a flush cake is considerably higher, the volume of flush cake being nearly half compared to press cake with same amount of pigment, the demand for logistic, storage capacity and transportation of the pigment, is correspondingly less.

The flush cake may be processed to a finished printing ink by a process comprising adding non-pigment ink components of the finished printing ink directly to the flush cake while applying heat and/or vacuum to remove residual water.

The flush cake is processed to a finished printing ink by a process comprising flushing the flush cake to yield a flushed pigment, applying heat and/or a vacuum to the flushed pigment to remove residual water to yield a drier flushed pigment, and adding non-pigment ink components of the finished printing ink to the drier flushed pigment.

The invention will now be described in greater detail with reference to the following non-limiting examples:

### EXAMPLES

### Example 1

A. A 4-6% Pigment Yellow 13 slurry was made in the conventional way. This slurry containing 489.3 parts of pigment was mixed with 249.6 parts of varnish and 99.8 parts of oil. The slurry was stirred for 1 hour whereupon most of the water was removed by filtration. The resultant product is hereafter referred to as “flush cake.”

B. The resultant flush cake, containing 27 wt. % of water based on the weight of the flush cake was then transferred to a mixer wherein the residual water was removed by vacuum. The dried flush mass was cut back with oil and varnish to achieve a standardized flush paste adjusted to the same plastic viscosity and yield value as the standard measured on a Laray Bar Viscometer at a shear rate of D=2000 s¹.

### Example 2

100 g of the flush cake produced in example 1A was placed in a tank equipped with a stirrer and blended with conventional raw materials for printing ink production such as varnish, oil and alkyd. The water was simultaneously evaporated to get a printing ink containing 11.1% of pigment with 0.2% of water.

### Example 3

A flush cake and a flush paste were made according to Example 1 with the exception that a slurry containing 4-6% of a mixture of Pigment Yellow 13 and Pigment Yellow 14 was used instead of Pigment Yellow 13.

### Example 4

A printing ink was made according to Example 2 with the exception that the flush cake in Example 3 was used instead of using the flush cake in Example 1A.

### Example 5

A flush cake and a flush paste were made according to Example 1 with the exception that a slurry containing 4-6% of Pigment Yellow 12 instead of Pigment Yellow 13 was used.

### Example 6

A printing ink was made according to Example 2 with the exception that the flush cake in Example 5 was used instead of using the flush cake in Example 1A.

### Example 7

A flush cake and a flush paste were made according to Example 1 with the exception that a slurry containing 4-6% of a mixture of Pigment Yellow 12 and Pigment Yellow 13 instead of Pigment Yellow 13 was used.

### Example 8

A printing ink was made according to Example 2 with the exception that the flush cake in Example 7 was used instead of using the flush cake in Example 1A.

### Example 9

A. A 5-7% Pigment Red 57:1 slurry was made in the conventional way. This slurry containing 1806 parts of pigment was mixed with 479 parts of oil, 1484 parts of varnish, 479 parts of alkyd, and 52 parts of antioxidant. The slurry was stirred for 2 hours and subsequently most of the water was removed by filtration.

B. The resultant flush cake containing 20% of water was then transferred to a mixer wherein the residual water was removed by vacuum and the dried flush mass was then cut back with oil, varnish, and alkyd to achieve a standardized flush paste.

### Example 10

A. A 5-7% Pigment Red 57:1 slurry was made in the conventional way. This slurry containing 521 parts of pigment was mixed with 326 parts of oil, 425 parts of varnish, 124.2 parts of alkyd, and 14.7 parts of antioxidant. The slurry was stirred for 75 minutes, whereupon most of the water was removed by filtration.

B. The resultant flush cake containing 23% of water was then transferred to a container equipped with a mixer and blended with conventional raw materials for printing ink production, comprising varnish, oil, extender, and antioxidant. The water was simultaneously removed by vacuum, and the product obtained hereby was a finished printing ink containing 12.9% of pigment and 0.5% of water.

### Example 11

A flush cake and a flush paste were made according to Example 9 with the exception that a slurry containing 3-7% of Pigment Red 48:2 was used instead of Pigment Red 57:1.

### Example 12

A printing ink was made according to Example 10 with the exception that a slurry containing 3-7% of Pigment Red 48:2 was used instead of using the slurry of Pigment Red 57:1.

### Example 13

A flush cake and a flush paste were made according to Example 11 with the exception that a slurry containing 3-7% of a mixture of Pigment Red 48:2 and pigment Red 48:3 was used instead of Pigment Red 48:2.

### Example 14

A printing ink was made according to Example 12 with the exception that a slurry containing 3-7% of a mixture of Pigment Red 48:2 and Pigment Red 48:3 was used instead of using the slurry of Pigment Red 57:1.

### Example 15

The printing inks of the present invention prepared according to Examples 1, 3, 5, 7, 9, 11, and 13 were compared to the same base pigments tested in drawdown, which is a conventional way to test pigments, for evaluation of the color strength of the pigment.

Inks prepared from flush pastes as produced according to Example 1, 3, 5, 7, 9B, 11 and 13 were compared to the inks prepared in Examples 2, 4, 6, 8, 10B, 12 and 14, respectively, and showed identical color strength (Datacolor, Spectraflash SF650X) and offered similar rheology (measured on a Laray viscometer and Churchill drop-rod), inclusive of flow (measured on a flow-plate), tack (measured on a tack-o-scope), grind (measured on a grind gauge), lithography and more importantly improved misting characteristics (measured on a tack-o-scope).

It should be understood that the preceding detailed description of the invention is merely a detailed description of one preferred embodiment or of a small number of preferred embodiments of the present invention and that numerous changes to the disclosed embodiment(s) can be made in accordance with the disclosure herein without departing from the spirit or scope of the invention. The preceding detailed description of the invention, therefore, is not meant to limit the scope of the invention in any respect. Rather, the scope of the invention is to be determined only by the appended issued claims and their equivalents.

What is claimed is:

1. A process for the production of a printing ink, said process comprising the following steps:
(a) providing an aqueous pigment slurry;
(b) adding at least one non-pigment printing ink component immiscible in water to said aqueous pigment slurry to produce a flush cake; and
(c) processing said flush cake to a finished printing ink.

2. The process according to claim 1, wherein the at least one non-pigment printing ink component immiscible in water is an oil, a varnish, an alkyd, a non-aqueous hydrophobic ink vehicle, and mixtures thereof.

3. The process according to claim 1, wherein the processing step (c) further comprises applying heat and/or a vacuum to remove residual water.

4. The process according to claim 3, wherein the processing step (c) further comprises adding a second non-pigment component immiscible in water.

5. The process according to claim 4 wherein the second non-pigment ink components are one or more oils, varnishes, alkyds, extenders and/or antioxidants.

6. The process according to claim 1, wherein the flush cake is processed to a finished printing ink by a process comprising flushing the flush cake to yield a flushed pigment, applying heat and/or a vacuum to the flushed pigment to remove residual water to yield a drier flushed pigment, and adding non-pigment printing ink components of the finished printing ink to the drier flushed pigment.

7. The process according to claim 6, wherein the non-pigment printing ink components are one or more oils, varnishes, alkyds, extenders, antioxidants, and mixtures thereof.

8. A flush cake comprising a pigment and at least one non-pigment ink component immiscible in water.

9. A flush cake according to claim 8 wherein the non-pigment printing ink component immiscible in water is an oil, a varnish, an alkyd, a non-aqueous hydrophobic ink vehicle, and mixtures thereof.

10. A printing ink comprising:
(a) a flush cake comprising a pigment and at least one non-pigment printing ink component immiscible in water; and
(b) a second non-pigment printing ink component.

11. A printing ink according to claim 10 wherein the non-pigment printing ink component immiscible in water is an oil, a varnish, an alkyd, a non-aqueous hydrophobic ink vehicle, and mixtures thereof.
